(19) United States
(12) Patent Application Publication
(10) Pub. No.: US 2026/0261807 A1
(43) Pub. Date: Sep. 3, 2026

(54) Method for audio processing in a hearing device to provide for a gain adjustment

(71) Applicant: SONOVA AG, Staefa (CH)

(72) Inventors: Christophe Lesimple, Fribourg (CH); Volker Kühnel, Männedorf (CH)

(21) Appl. No.: 19/529,758

(22) Filed: Feb. 4, 2026

(30) Foreign Application Priority Data
Mar. 3, 2025 (EP) 25161371.7

(51) Int. Cl. H04R 25/00

(52) U.S. Cl. CPC H04R 25/43; H04R 25/356; H04R 2225/41; H04R 2225/43

(57) ABSTRACT

A method of audio processing in a hearing device to provide for a gain adjustment includes receiving an audio signal from an audio input unit; processing the audio signal in a first path and a second path, wherein each path is associated with detecting a signal level of the audio signal for applying a gain adjustment to the audio signal depending on the signal level, and wherein the processing in the first path is adapting faster to changes of the signal level than the processing in the second path; generating a mixed signal by mixing the audio signal processed in the first path and the audio signal processed in the second path in accordance with a mixing ratio; and providing an output signal based on the mixed signal for an audio output unit configured to output the output signal.

### RELATED APPLICATIONS

The present application claims priority to EP Patent Application No. 25161371.7, filed March 3, 2025, which is hereby incorporated by reference in its entirety.

### BACKGROUND INFORMATION

Hearing devices may be used to improve the hearing capability or communication capability of a user, for instance by compensating a hearing loss of a hearing-impaired user, in which case the hearing device is commonly referred to as a hearing instrument such as a hearing aid, or hearing prosthesis. A hearing device may also be used to output sound based on an audio signal which may be communicated by a wire or wirelessly to the hearing device. A hearing device may also be used to reproduce a sound in a user’s ear canal detected by an input transducer such as a microphone or a microphone array. The reproduced sound may be amplified to account for a hearing loss, such as in a hearing instrument, or may be output without accounting for a hearing loss, for instance to provide for a faithful reproduction of detected ambient sound and/or to add audio features of an augmented reality in the reproduced ambient sound, such as in a hearable. A hearing device may also provide for a situational enhancement of an acoustic scene, e.g. beamforming and/or active noise cancelling (ANC), with or without amplification of the reproduced sound. A hearing device may also be implemented as a hearing protection device, such as an earplug, configured to protect the user’s hearing. Different types of hearing devices configured to be be worn at an ear include earbuds, earphones, hearables, and hearing instruments such as receiver-in-the-canal (RIC) hearing aids, behind-the-ear (BTE) hearing aids, in-the-ear (ITE) hearing aids, invisible-in-the-canal (IIC) hearing aids, completely-in-the-canal (CIC) hearing aids, cochlear implant systems configured to provide electrical stimulation representative of audio content to a user, a bimodal hearing system configured to provide both amplification and electrical stimulation representative of audio content to a user, or any other suitable hearing prostheses. A hearing system comprising two hearing devices configured to be worn at different ears of the user is sometimes also referred to as a binaural hearing device. A hearing system may also comprise a hearing device, e.g., a single monaural hearing device or a binaural hearing device, and a user device, e.g., a smartphone and/or a smartwatch, communicatively coupled to the hearing device.

Hearing devices are often employed in conjunction with communication devices, such as smartphones or tablets, for instance when listening to sound data processed by the communication device and/or during a phone conversation operated by the communication device. More recently, communication devices have been integrated with hearing devices such that the hearing devices at least partially comprise the functionality of those communication devices. A hearing system may comprise, for instance, a hearing device and a communication device.

Advanced audio signal processing techniques have been developed to improve a hearing experience for users in various fields. Some important audio processing applications rely on dynamic range compression (DRC) to adjust amplification based on the input sound pressure level (SPL). This technique ensures that soft sounds remain audible while preventing loud sounds from becoming uncomfortably intense. Over the years, different DRC strategies have been developed to optimize speech intelligibility and listening comfort. Research indicates that fast-acting DRC enhances speech clarity in quiet environments by quickly adjusting gain to speech fluctuations, while slow-acting DRC performs better in noisy environments by maintaining a more stable gain adjustment. Recognizing the benefits of both approaches, hybrid solutions have been adopted that employ both fast-acting and slow-acting DRC in parallel, dynamically selecting the appropriate compression strategy depending on the acoustic scene.

Those dual compression systems have been implemented in different ways. Examples are disclosed in US 2011/0013794 A1, EP 3 358 745 A1, US 9,408,001 B2, and US 8,019,105 B2. Some systems operate by independently selecting either the fast-acting or slow-acting DRC based on environmental classification, while others blend the gain contributions of both compression types in a weighted manner. One prevalent approach is to adjust the contribution of fast-acting gain versus the slow-acting gain in a mixing ratio. This mixing ratio is influenced by factors such as the chosen fitting rationale, manually selected hearing aid programs, or, most commonly, automatically by a classification of the listening environment. When the classifier of the listening environment is used to adjust the gain automatically, it is intended to provide an optimal balance between audibility and listening comfort without requiring user intervention.

Despite the advantages of classifier-driven gain adjustments, there are notable limitations. One significant drawback is the slow adaptation speed when transitioning between acoustic environments. For instance, when transitioning to a noisy setting or in a noisy setting where speech suddenly begins, it may take up to 20 seconds for the FGW to reach the desired value, causing suboptimal gain settings at the beginning of a speech setting. This lag can lead to missed speech cues, particularly during the rather critical initial moments of a conversation, negatively impacting the communication and reducing the effectiveness of the dual compression strategy.

Another drawback of classifier-driven gain adjustment is its susceptibility to unpredictable changes. The classifier may alter the gain without any discernible or clear acoustic trigger, introducing unnecessary modulations in the output signal. These unintended fluctuations can result in inconsistent amplification and an unnatural listening experience for the user.

Another challenge arises in binaural hearing aids, where classifier behavior may not be perfectly synchronized between the left and right devices, leading to unsynchronized gain values between the left and right hearing devices and inconsistencies in gain adjustments. This lack of synchronization can further degrade speech perception and spatial awareness, particularly in dynamic acoustic environments where precise coordination between both ears is essential.

### BRIEF DESCRIPTION OF THE DRAWINGS

Reference will now be made in detail to embodiments, examples of which are illustrated in the accompanying drawings. The drawings illustrate various embodiments and are a part of the specification. The illustrated embodiments are merely examples and do not limit the scope of the disclosure. Throughout the drawings, identical or similar reference numbers designate identical or similar elements. In the drawings:

FIG. 1 schematically illustrates an exemplary hearing device;

FIG. 2 schematically illustrates an embodiment of the hearing device illustrated in FIG. 1 as a RIC hearing aid;

FIGS. 3 - 5 schematically illustrate block diagrams of exemplary signal processing algorithms for detecting a signal level on separate signal paths to provide for a gain adjustment on;

FIGS. 6 - 8 illustrate exemplary functional plots associated with a mixing scheme depending on a noise floor;

FIGS. 9, 10 schematically illustrate block diagrams of exemplary signal processing algorithms to provide for a gain adjustment in a hearing device;

FIGS. 11, 12 illustrate empirical measurements of various characteristics of an acoustic environment block diagrams, and a mixing ratio determined depending on characteristics of the acoustic environment; and

FIG. 13 schematically illustrates an exemplary method of processing an audio signal according to principles described herein.

### DETAILED DESCRIPTION

It is a feature of the present disclosure to avoid at least one of the above mentioned disadvantages and to provide for an improvement of current audio processing methods for gain adjustments depending on the SPL of the audio signal, in particular in the context of DRC. It is another feature to improve the responsiveness of the gain adjustments, in particular the adaption of gain compression, to changes in the acoustic environment, ensuring that users receive optimal gain settings in a timely manner. A further feature is to enhance the stability of the gain adjustments, e.g., by reducing unwanted fluctuations which may be caused by classifier inconsistencies, and/or to improve the reliability of compression systems. A further feature is to achieve better synchronization of binaural processing, e.g., by ensuring that both hearing devices apply gain compression in a coordinated manner to preserve spatial cues, and/or to provide a more natural listening experience. It is yet another feature to enhance one or more of a speech intelligibility, listening comfort, and overall user satisfaction in diverse acoustic environments.

Accordingly, the present disclosure proposes a method of audio processing in a hearing device to provide for a gain adjustment, the method comprising

receiving an audio signal from an audio input unit;

processing the audio signal in a first path and a second path, wherein each path is associated with detecting a signal level of the audio signal for applying a gain adjustment to the audio signal depending on the signal level, and wherein the processing in the first path is adapting faster to changes of the signal level than the processing in the second path;

estimating a noise floor of the audio signal;

determining a mixing ratio depending on the noise floor;

generating a mixed signal by mixing the audio signal processed in the first path and the audio signal processed in the second path in accordance with the mixing ratio; and

providing an output signal based on the mixed signal for an audio output unit configured to output the output signal.

Independently, the present disclosure proposes a non-transitory computer-readable medium storing instructions that, when executed by a processor, which may be included in a hearing device, cause a hearing device to perform the method.

Independently, the present disclosure proposes a hearing device configured to be worn at an ear of a user, the hearing device comprising an audio input unit for obtaining an audio signal; a processor for audio signal processing of the audio signal to obtain an output signal, wherein the processor is configured to perform the method; and an audio output unit for outputting the output signal so as to stimulate the user’s hearing.

Subsequently, additional features of some implementations of the method and/or the hearing device and/or the computer readable medium are described. Each of those features can be provided solely or in combination with at least another feature. The features can be correspondingly provided in some implementations of the method and/or the hearing device and/or the computer readable medium.

In some implementations, the mixing ratio is determined such that, within a predetermined value range of the noise floor, the mixed signal comprises a larger proportion of the audio signal processed in the first path when the noise floor is estimated at a smaller value, and a smaller proportion of the audio signal processed in the first path when the noise floor is estimated at a larger value.

In some implementations, the method further comprises estimating a signal to noise ratio (SNR) of the audio signal; and determining the mixing ratio further depending on the SNR.

In some implementations, the mixing ratio is determined such that the mixed signal comprises a larger proportion of the audio signal processed in the first path when the SNR is estimated at a larger value, and a smaller proportion of the audio signal processed in the first path when the SNR is estimated at a smaller value.

In some implementations, said predetermined value range of the noise floor is shifted to larger values of the noise floor with increasing values of the SNR.

In some implementations, the mixing ratio is determined such that the mixed signal comprises a proportion of the audio signal processed in the first path of at least 30%, in some examples at least 35%, e.g., at least 40%.

In some implementations, the determining the mixing ratio depending on the noise floor comprises evaluating the noise floor in a mixing scheme defining a mapping between different values of the noise floor and corresponding values of the mixing ratio. E.g., the mixing scheme may comprise one or more weightings applied on the first and/or second path, for instance a fast gain weight (FGW) applied on the first path. In some examples, the mixing scheme defines a predetermined relationship between the noise floor and the mixing ratio.

In some implementations, the mixing scheme comprises a value range of the noise floor in which the mixing ratio is determined such that, with increasing values of the noise floor, a proportion of the audio signal processed in the first path decreases in the mixed signal relative to a proportion of the audio signal processed in the second path. In some examples, the proportion of the audio signal processed in the first path decreases monotonously and/or continuously and/or linearly within the value range.

In some implementations, the method further comprises determining the mixing scheme depending on the SNR such that, at least in a predetermined value range of the SNR, said value range of the noise floor is shifted to larger values of the noise floor with increasing values of the SNR.

In some implementations, the mixing scheme includes a first weighting for the audio signal processed in the first path and/or a second weighting for the audio signal processed in the second path, wherein the mixing ratio is defined by the first weighting and/or the second weighting. In some implementations, the first weighting is a weighting factor and/or the second weighting is a weighting factor.

In some implementations, with increasing values of the noise floor, the first weighting decreases in said value range of the noise floor and/or the second weighting increases in said value range of the noise floor. In some implementations, the first weighting defines a proportion of the audio signal processed in the first path included in the mixed signal and/or the second weighting defines a proportion of the audio signal processed in the second path included in the mixed signal.

In some implementations, the proportion defined by the first weighting and/or the second weighing is between 0% and 100%. In some examples, the proportion defined by the first weighting is between 10% and 100%, in particular between 30% and 100%, e.g., between 40% and 100%. In some implementations, the proportion defined by one of the first weighting and/or the second weighing is determined as the difference between 100% and the proportion of the other of the first weighting and/or the second weighting.

In some implementations, the generating the mixed signal comprises applying the first weighting to the audio signal processed in the first path and/or applying the second weighting to the audio signal processed in the second path; and combining the audio signal processed in the first path and the audio signal processed in the second path.

In some implementations, the method further comprises providing for the gain adjustment of the audio signal based on the mixed signal. In some implementations, the output signal is based on the mixed signal such that the gain adjustment is provided for in the output signal.

In some implementations, the method further comprises determining, in a first gain value determining operation, a gain value for the gain adjustment in the first path depending on the signal level so as to provide for a first gain value signal indicative of the determined gain value; and determining, in a second gain value determining operation, a gain value for the gain adjustment in the second path depending on the signal level so as to provide for a second gain value signal (SG2) indicative of the determined gain value.

In some implementations, in the first and/or second gain value determining operation, the gain value is determined in accordance with a gain table defining a mapping between different values of the signal level to corresponding values of the gain value. In some implementations, the gain table is determined in a fitting of the hearing device to a hearing loss of the user.

In some implementations, the method further comprises smoothing the first gain value signal in a first smoothing operation performed during the processing in the first path, and smoothing the second gain value signal in a second smoothing operation performed during the processing in the second path.

In some implementations, a delay caused by the first smoothing operation is smaller as compared to the second smoothing operation.

In some implementations, the first smoothing operation is performed after the first gain value determining operation, and the second smoothing operation is performed after the second gain value determining operation.

In some implementations, the first smoothing operation is adjustable depending on a characteristic of the audio signal, wherein the adjustment impacts a delay caused by the first smoothing operation. In some implementations, the method further comprises detecting a presence of an onset in the audio signal, wherein the characteristic of the audio signal comprises the onset.

In some implementations, the first weighting is applied to the audio signal after the first smoothing operation, and the second weighting is applied to the audio signal between the second gain value determining operation and the second smoothing operation.

In some implementations, the method further comprises detecting, in a first level detection operation, the signal level of the audio signal during the processing of the audio signal in the first path so as to provide a first level detection signal indicative of the detected signal level; and detecting, in a second level detection operation, the signal level of the audio signal during the processing of the audio signal in the second path so as to provide a second level detection signal indicative of the detected signal level. In some implementations, in the first level detection operation, a first level detection signal indicative of the detected signal level is provided. In some implementations, in the second level detection operation, a second level detection signal indicative of the detected signal level is provided.

In some implementations, a delay caused by the first level detection operation is smaller as compared to the second level detection operation.

In some implementations, the method further comprises smoothing the first level detection signal in a first smoothing operation performed during the processing in the first path, and smoothing the second level detection signal in a second smoothing operation performed during the processing in the second path. In some implementations, a delay caused by the first smoothing operation is smaller as compared to the second smoothing operation. In some implementations, the first smoothing operation is adjustable depending on a characteristic of the audio signal, wherein the adjustment impacts a delay caused by the first smoothing operation. In some implementations, the method further comprises detecting a presence of an onset in the audio signal, wherein the characteristic of the audio signal comprises the onset.

In some implementations, the method further comprises determining, in a first gain determining operation, a gain to be applied on audio signal SI based on the first level detection signal during the processing of the audio signal in the first path, and determining, in a second gain determining operation, a gain to be applied on audio signal SI based on the second level detection signal during the processing of the audio signal in the second path.

In some implementations, the method comprises providing, after the processing of the audio signal in the first path, a first intermediate signal, and providing, after the processing of the audio signal in the second path, a second intermediate signal, wherein the mixed signal is generated by mixing the first intermediate signal and the second intermediate signal according to the mixing ratio. In some implementations, the first intermediate signal comprises the first level detection signal, e.g., after the first smoothing operation has been applied on the first level detection signal, and the second intermediate signal comprises the second level detection signal, e.g., after the second smoothing operation has been applied on the second level detection signal. In some implementations, the first intermediate signal comprises the first gain value signal, e.g., after the first smoothing operation has been applied on the first gain value signal, and the second intermediate signal comprises the second gain value signal, e.g., after the second smoothing operation has been applied on the second gain value signal.

In some implementations, the gain is adjustment provides for a dynamic range compression (DRC). In some implementations, the signal level of the audio signal is representative of a sound level, e.g., a sound pressure level (SPL).

The disclosure relates to a method of processing an audio signal in a hearing device. The disclosure further relates to a hearing device configured to perform the method.

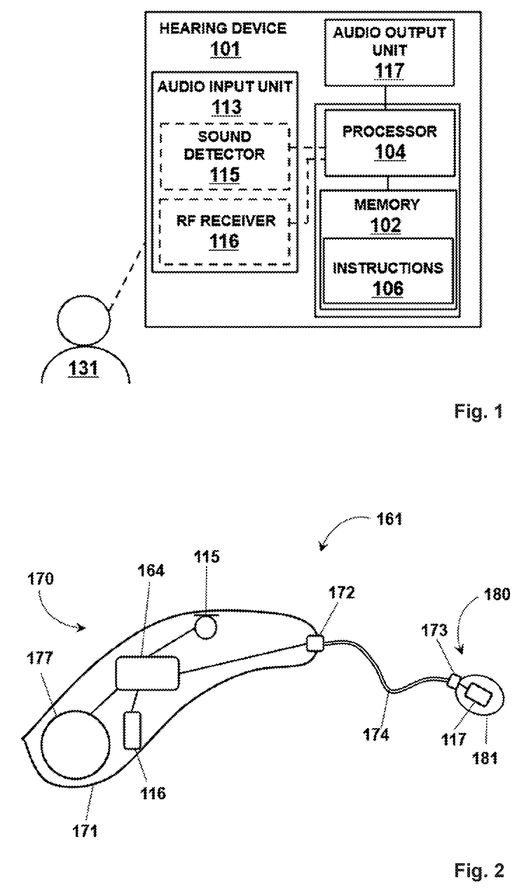

FIG. 1 illustrates an exemplary implementation of a hearing device 101 configured to be worn at an ear of a user 131. Hearing device 101 may be implemented by any type of hearing device configured to enable or enhance hearing or a listening experience of user 131 wearing hearing device 101. For example, hearing device 101 may be implemented by a hearing aid configured to provide an amplified version of audio content to a user, a sound processor included in a cochlear implant system configured to provide electrical stimulation representative of audio content to a user, a sound processor included in a bimodal hearing system configured to provide both amplification and electrical stimulation representative of audio content to a user, an over-the-counter (OTC) hearing device, or any other suitable hearing prosthesis, or an earbud or an earphone or any other hearable.

In certain examples, hearing device 101 may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

Different types of hearing device 101 can also be distinguished by the position at which they are worn at the ear. Some hearing devices, such as behind-the-ear (BTE) hearing aids and receiver-in-the-canal (RIC) hearing aids, typically comprise an earpiece configured to be at least partially inserted into an ear canal of the ear, and an additional housing configured to be worn at a wearing position outside the ear canal, in particular behind the ear of the user. Some other hearing devices, as for instance earbuds, earphones, hearables, in-the-ear (ITE) hearing aids, invisible-in-the-canal (IIC) hearing aids, and completely-in-the-canal (CIC) hearing aids, commonly comprise such an earpiece to be worn at least partially inside the ear canal without an additional housing for wearing at the different ear position.

Hearing device 101 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.).

Memory 102 may maintain (e.g., store) executable data used by processor 104 to perform any of the operations associated with hearing device 101. For example, memory 102 may store instructions 106 that may be executed by processor 104 to perform any of the operations associated with hearing device 101 assisting a user in hearing and/or any of the operations described herein. To illustrate, instructions 106 may include instructions for a gain adjustment of an audio signal depending on a signal level of the audio signal, e.g., instructions for gain compression and/or DRC. In some examples, instructions 106 may further include audio signal processing routines providing for noise cancelling, feedback cancelling, beamforming, speech enhancement, audio signal classification, audio signal processing programs associated with a current acoustic scene, binaural synchronization, and/or the like. Instructions 106 may be implemented by any suitable application, software, firmware, code, and/or other executable data instance.

Processor 104 may be configured to perform any suitable processing operation associated with hearing device 101. For example, when hearing device 101 is implemented by a hearing instrument, such processing operations may include monitoring ambient sound and/or presenting amplified sound to user 131 via an in-ear receiver. Processor 104 may be implemented by any suitable combination of hardware and software.

As shown in FIG. 1, hearing device 101 may further include an audio input unit 113 and an audio output unit 117 communicatively coupled to processor 104. Audio input unit 113 is configured to obtain an input audio signal. Processor 104 is configured to provide for a processing of the input audio signal to obtain an output audio signal. Audio output unit 117 is configured to output sound based on the output audio signal.

In some implementations, as illustrated, audio input unit 113 may comprise a sound detector 115 configured to detect sound in an ambient environment of the user and to provide an ambient audio signal representative of the detected sound. The input audio signal, which is received by processor 104, may then at least partially be based on the ambient audio signal. In some examples, sound detector 115 may be implemented as a microphone and/or a microphone array. In some examples, after detection of the sound in the ambient environment, audio input unit 113 may be configured to prepare the ambient audio signal for an audio signal processing by processor 104. For example, audio input unit 117 may comprise an analog-to-digital converter to convert the ambient audio signal, as detected by sound detector 115, from an analog signal into a digital signal.

In some implementations, as illustrated, audio input unit 113 may comprise a radio receiver 116 configured to receive a radio audio signal from a remote audio source via radio frequency (RF) radiation. The input audio signal, which is received by processor 104, may then at least partially be based on the radio audio signal. Radio receiver 116 may be configured for wireless data reception of the radio audio signal. For instance, the radio audio signal may be received in accordance with a Bluetooth^{TM} protocol and/or by any other type of RF communication. In some examples, the remote audio source may be a remote microphone, e.g., a table microphone or a clip-on microphone, configured to detect sound at a remote location and transmit the radio audio signal indicative of the detected sound to radio receiver 116. In some examples, the remote audio source may be a streaming source configured for streaming the radio audio signal to radio receiver 116. In some examples, the remote audio source may be a communication device, e.g., a portable device such as a smartphone, tablet, smartwatch and/or the like, or a computing device such as a personal computer, configured for data transmission of the radio audio signal to radio receiver 116. In some examples, after reception of the radio audio signal, audio input unit 113 may be configured to prepare the radio audio signal for an audio signal processing by processor 104. For example, when the radio audio signal received from the remote audio source comprises an encoded signal, audio input unit 113 may comprise a decoder to decode the radio audio signal.

Audio output unit 117 may be implemented by any suitable audio output device configured to output sound based on the output audio signal to the user. To this end, audio output unit 117 may include an output transducer. For example, audio output unit 117 may be implemented as a receiver of a hearing aid, a loudspeaker of an earbud, or an output electrode of a cochlear implant.

Hearing device 101 may include further components as may serve a particular implementation. E.g., hearing device 101 may further include a user interface and/or a communication port for data transmission and/or an ear-canal microphone and/or other sensors such as a motion sensor and/or a physiological sensor.

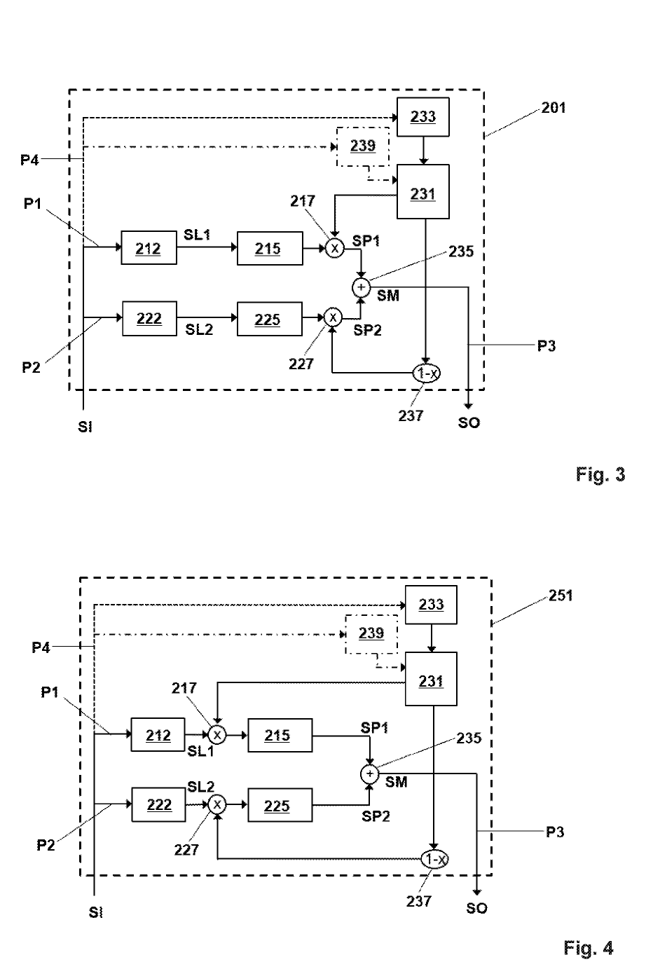

FIG. 2 illustrates an exemplary implementation of hearing device 101 as a RIC hearing aid 161. RIC hearing aid 161 comprises a BTE part 170 configured to be worn at an ear at a wearing position behind the ear, and an ITE part 180 configured to be worn at the ear at a wearing position at least partially inside an ear canal of the ear. BTE part 170 comprises a BTE housing 171 configured to be worn behind the ear. BTE housing 171 accommodates a processing unit 164, which may comprise processor 104 and memory 102, communicatively coupled to sound detector 115 and radio receiver 216. BTE part 170 further includes a battery 177 as a power source. ITE part 180 is an earpiece comprising an ITE housing 181 at least partially insertable into the ear canal. ITE housing 181 accommodates audio output unit 117 implemented as a receiver. BTE part 170 and ITE part 180 are interconnected by a cable 174. Processing unit 164 is communicatively coupled to audio output unit 117 of ITE part 180 via cable 174 and cable connectors 172, 173 provided at BTE housing 171 and ITE housing 181.

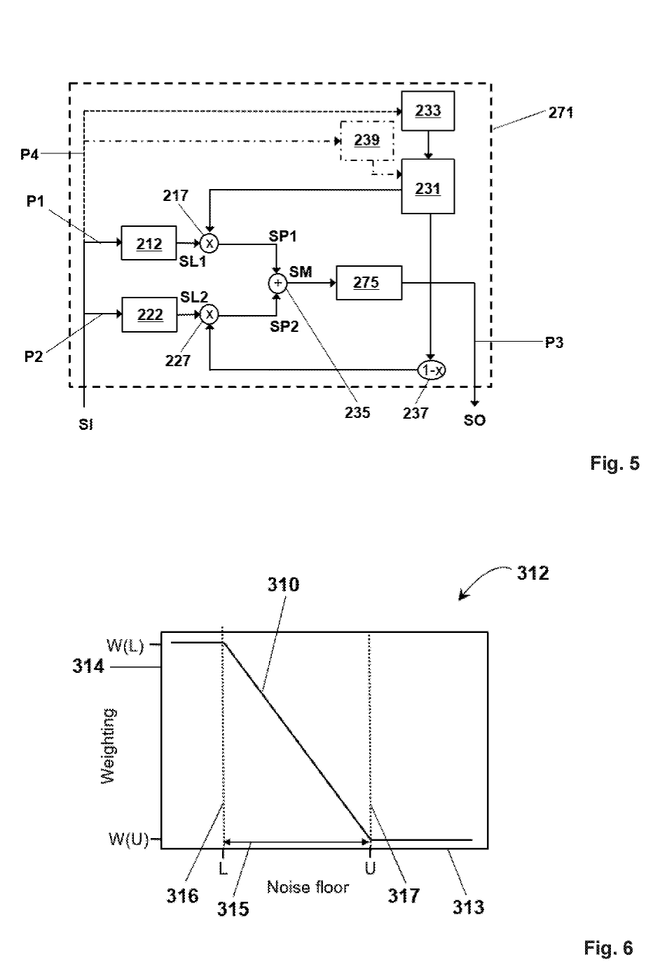

FIG. 3 is a schematic block diagram of a signal processing algorithm 201 for signal level detection of an audio signal SI on separate signal paths P1, P2 which can be employed to provide for a gain adjustment of audio signal SI depending thereon. Algorithm 301 may be executed by processor 104 after receiving audio signal SI from audio input unit 113 as an input audio signal. Processor 104 may process the received audio signal to obtain an output audio signal SO, which may be output by audio output unit 117 to stimulate the user’s hearing. Algorithm 201 may be applied during any stage of the processing of audio signal SI, e.g., before and/or after other processing operations which may be executed by processor 104.

After the processing of input audio signal SI at first path P1, a first intermediate signal SP1 is obtained. After the processing of input audio signal SI at second path P2, which is bypassing first path P1, a second intermediate signal SP2 is obtained. A mixed signal SM comprises first intermediate signal SP1 and second intermediate signal SP2 mixed in accordance with a mixing ratio. Mixed signal SM may then be passed on at an outgoing signal path P3, which may comprise further processing routines so as to perform one or more subsequent operations and/or may lead to one or more further signal paths, so as to obtain output audio signal SO.

Algorithm 201 comprises a first level detector 212 at first path P1, and a second level detector 222 at second path P2. First level detector 212 is configured to detect, in a first level detection operation, a signal level of audio signal SI so as to provide for a first level detection signal SL1 indicative of the detected signal level. A time constant t1 may be characteristic for the time required to perform the first level detection operation. The time constant t1 may include an attack and/or a release time. Second level detector 212 is configured to detect the signal level in a second level detection operation, for which a time constant t2 may be characteristic, so as to provide for a second level detection signal SL2 indicative of the detected signal level. The signal level may be indicative of a sound level, e.g., a sound pressure level (SPL).

Algorithm 201 further comprises a first gain determining module 215 at first path P1, and a second gain determining module 225 at second path P2. First gain determining module 215 is configured to determine, in a first gain determining operation, a gain to be applied on audio signal SI depending on the signal level detected in the first level detection operation. First intermediate signal SP1 can thus be indicative of a gain to be applied on audio signal SI in a gain adjustment. Second gain determining module 225 is configured to determine, in a second gain determining operation, a gain to be applied on audio signal SI depending on the signal level detected in the second level detection operation. Second intermediate signal SP2 can thus also be indicative of a gain to be applied on audio signal SI in a gain adjustment.

The processing performed in first path P1 is adapting faster to changes of the signal level of audio signal SI than the processing in second path P2. In some examples, first path P1 is associated with a quicker adjustment of the gain determination to temporal fluctuations in audio signal SI, e.g., speech fluctuations, as compared to second path P2. In some examples, second path P2 is associated with a maintenance of a more stable gain determination as compared to second path P2, which may be beneficial, e.g., in noisy environments.

In some examples, first level detector 212 is configured to detect the signal level of audio signal SI faster than second level detector 222. E.g., time constant t1 may be smaller than time constant t2. E.g., a number of frequency bands of audio signal SI for which the signal level of audio signal SI is detected by first level detector 212 may be smaller than the number of frequency bands detected by second level detector 222. A delay caused bythe first level detection operation may thus be smaller as compared to the second level detection operation.

In some examples, first gain determining module 215 is configured to determine the gain of audio signal SI faster than second gain determining module 225. E.g., a determining of a gain value, for example a gain calculation, may be performed faster by first gain determining module 215 as compared to second gain determining module 225. E.g., a smoothing of the processed audio signal SI before and/or after determining the gain value may be performed faster by first gain determining module 215 as compared to second gain determining module 225. A delay caused bythe first gain determining operation may thus be smaller as compared to the second gain determining operation.

Mixed signal SM is generated by mixing audio signal SI processed in first path P1 and audio signal SI processed in second path P2 in accordance with a mixing ratio. In the illustrated example, the mixing ratio is defined by a first weighting 217, e.g., a weighting parameter such as a weighting factor, applied to audio signal SI during processing in first path P1 and a second weighting 227 applied to audio signal SI during processing in second path P2. After applying first and second weighting 217, 227, first intermediate signal SP1 and second intermediate signal SP2 are combined, e.g., added or summed up, by a signal combiner 235. Mixed signal SM can thus be indicative of a gain for a gain adjustment to be applied on audio signal SI, e.g., in a subsequent processing of audio signal SI.

In the illustrated example, first weighting 217 is a weighting factor x between zero and one. Further, in the illustrated example, second weighting 227 is a weighting factor which corresponds to a difference 1-x between one and first weighting factor 217. To this end, the difference 1-x may be determined by a subtraction module 237.

First weighting 217 may also be referred to as a fast gain weight (FGW). In some examples, the FGW determines a proportion of mixed signal SM derived from first path P1 as compared to a proportion of mixed signal SM derived from second path P2. To illustrate, the proportion of mixed signal SM derived from first path P1 may vary between 0% and 100%, in some examples between 20% and 100%, and in some other examples between 40% and 100%. E.g., when the gain is determined by first and second gain determining module 215, 225 to provide for a dynamic range compression (DRC), the FGW may determine the proportion of the fast-acting DRC relative to the slow-acting DRC.

In the illustrated example, first weighting 217 is applied on first path P1 after the first gain determining operation performed by first gain determining module 215. Second weighting 227 is applied on second path P2 after the second gain determining operation performed by second gain determining module 225. In this way, weightings 217, 227 may be applied on the processed audio signal SI indicative of the gain to be applied on audio signal SI. Applying weightings 217, 227 rather late or at the end of paths P1, P2 may be advantageous to account for a time consumption required to determine the mixing ratio based on which mixed signal SM is generated, as described below.

The mixing ratio, in particular first weighting 217 and/or second weighting 227, may be determined by a mixing ratio determination module 231. Mixing ratio determination module 231 can be configured to determine the mixing ratio depending on a noise floor of audio signal SI. To this end, mixing ratio determination module 231 receives an estimate of the noise floor from a noise floor estimator (NFE) 233. In some examples, NFE 231 can be configured to estimate the noise floor directly from audio signal SI, e.g., as illustrated, via a signal path P4. In other examples, NFE 233 can be configured to estimate the noise floor based on another signal which may be indicative of the noise floor of audio signal SI. E.g., NFE 233 may receive an auxiliary audio signal from another microphone included in audio input unit 113, wherein the auxiliary audio signal may also contain characteristics of the noise floor of audio signal SI.

In this way, by steering first weighting 217 (or, FGW) based on the noise floor estimated by NFE 233, a transparent blending between the fast and slow gain determining at paths P1, P2 can be provided for, wherein the noise floor estimate can provide for a more stable and/or faster response to changing acoustic conditions as compared to audio signal classification-based approaches. By integrating fast and slow gain determining strategies in such a way, algorithm 201 may balance the need for immediate responsiveness with the necessity of long-term signal stability. The fast reactiveness of the FGW based on the noise floor estimate steering the interaction between the two gain determining processes may thus allow for an optimized auditory experience, effectively handling rapid changes in signal dynamics while preserving the natural continuity of sounds. In particular, the fast gain steering by FGW 217 based on the noise floor estimate of NFE 233 may mitigate artifacts commonly associated with aggressive gain adjustments and contribute to a seamless, natural amplification process tailored to the needs of hearing device users.

The estimation of the noise floor can be performed using various techniques, which may include, but are not limited to, a statistical analysis, a spectral analysis, a comparison with a reference signal, adaptive filtering, machine learning based approaches, or hybrid approaches including any combination of those techniques. To illustrate, in some examples, a minimum statistics method is employed, wherein the noise floor is estimated by tracking the minimum energy level of the signal over a defined time window, assuming that the minimum observed level corresponds to the background noise. In some examples, a spectral subtraction technique may be utilized, in which the noise floor is estimated based on the difference between the current signal spectrum and a previously stored noise spectrum. Some examples involve the use of adaptive filtering, where an adaptive noise model is continuously updated based on signal characteristics, such as spectral flatness or modulation index, to distinguish noise from speech components. Some other examples rely on machine learning algorithms, where a trained model predicts the noise floor based on input features derived from the audio signal, such as statistical moments, temporal dynamics, or frequency-domain representations. In some examples, a voice activity detection (VAD)-based method may be applied, wherein the noise floor is estimated during periods classified as non-speech based on predefined thresholds or probabilistic models. Combinations of these techniques may be employed to enhance the noise estimation accuracy, particularly in dynamically changing acoustic environments.

In some examples, mixing ratio determination module 231 can be configured to determine the mixing ratio further depending on a signal to noise ratio (SNR) of audio signal SI. Mixing ratio determination module 231 may then receive an estimate of the SNR from an SNR estimator (SNRE) 239. SNRE 239 can be configured to estimate the SNR directly from audio signal SI, e.g., via signal path P4, or based on another signal which may be indicative of the SNR of audio signal SI. In some examples, the SNR may be estimated by calculating a power ratio between signal and noise of audio signal SI, which may be performed in a time-domain and/or frequency domain analysis. In some examples, SNRE 239 may be configured to provide for a smoothing of the SNR estimate, e.g., to reduce fluctuations and/or to enhance the quality of the estimate, for instance by applying a low-pass filter. The smoothed SNR estimate may then be received by mixing ratio determination module 231 in addition to the noise floor estimate of audio signal SI to determine the mixing ratio based thereon.

Determining the mixing ratio further depending on the SNR may further improve the performance of algorithm 201. In some examples, a larger value of the SNR may also result in a larger value of first weighting 217, at least within a predefined value range of the noise floor, as further described below. This may allow to compensate for a certain bias of the noise floor estimate in a quiet environment, e.g., a loud speech in quiet. In particular, when the environment is quiet, the resulting gain may thus not be excessively reduced and/or during periods of high speech intelligibility, a gain compression may minimized, preserving the natural sound quality.

FIG. 4 is a schematic block diagram of another signal processing algorithm 251 for signal level detection of audio signal SI on signal paths P1, P2 to provide for a gain adjustment depending thereon. In the illustrated example, first weighting 217 is applied on first path P1 after the first level detection operation performed by first level detector 212 and before the first gain determining operation performed by first gain determining module 215. Second weighting 227 is applied on second path P2 after the second level detection operation performed by second level detector 212 and before the second gain determining operation performed by second gain determining module 225. In this way, weightings 217, 227 may be applied on the detected signal levels of audio signal SI.

FIG. 5 is a schematic block diagram of another signal processing algorithm 271 for signal level detection of audio signal SI on signal paths P1, P2 to provide for a gain adjustment. In the illustrated example, a gain determining module 275 is provided at path P3 after first intermediate signal SP1 and second intermediate signal SP2 are combined by signal combiner 235. Accordingly, gain determining module 275 is configured to determine the gain to be applied on audio signal SI based on mixed signal SM. Before signals SP1 and SP2 are combined, the processing of audio signal SI at first path P1 comprises first level detection operation 212 followed by applying of first weighting 217, and the processing of audio signal SI at second path P2 comprises second level detection operation 222 followed by applying of second weighting 227. First intermediate signal SP1 can thus be indicative of the signal level of audio signal SI detected during the processing of audio signal SI in first path P1. Second intermediate signal SP2 can thus be indicative of the signal level of audio signal SI detected during the processing of audio signal SI in second path P2.

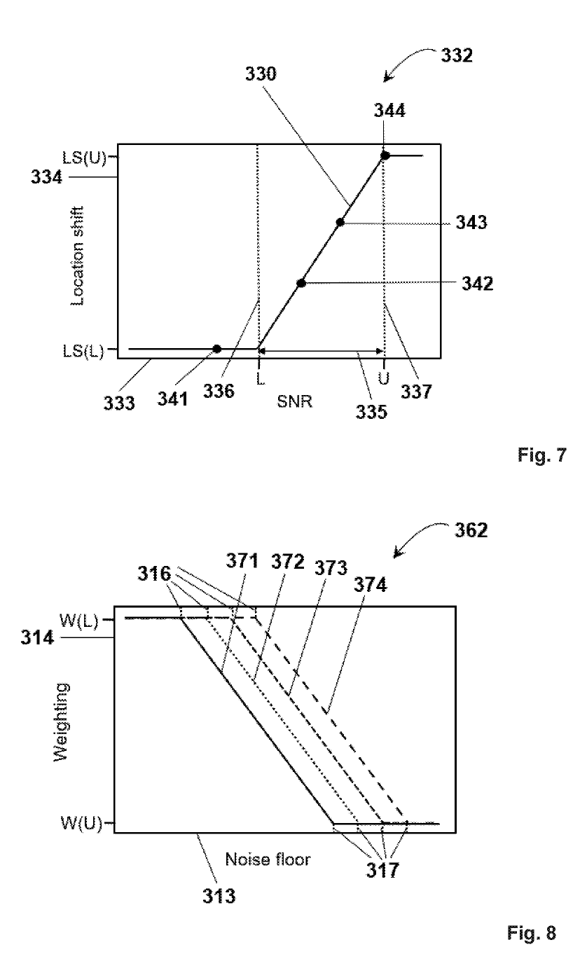

FIG. 6 illustrates a functional plot 313 of a mixing scheme 310 which may be applied on audio signal SI processed in first path P1 and/or second path P2 to determine the mixing ratio depending on the noise floor. Mixing scheme 310 defines a mapping of different values of the noise floor to corresponding values of the mixing ratio. The noise floor is indicated on an axis of abscissas 313. The mixing ratio is indicated on an axis of ordinates 314.

The mixing ratio may be defined, as indicated on axis of ordinates 314, by one of weightings 217, 227. In some examples, weighting 314 may be implemented as first weighting 217 applied on first path P1 and may then also be referred to as fast gain weight (FGW). In some examples, the weighting factor applied on second path P2 may then be determined as 1 – FGW, i.e., the difference between one and the FGW.

Weighting 314 comprises a value range 315 of noise floor 313 in which mixing ratio 314 is determined such that first intermediate signal SP1 constitutes a larger proportion of mixed signal SM when noise floor 313 is estimated at a smaller value, and a smaller proportion when noise floor 313 is estimated at a larger value. Value range 315 has a lower limit 316 defined by a lower value L of noise floor 313 and an upper limit 317 defined by an upper value U of noise floor 313. Correspondingly, weighting 314 assumes an upper value W(L) for the lower value L of noise floor 313, and a lower value W(U) for the upper value U of noise floor 313. A corresponding value range of weighting 314 may have a lower limit defined by lower value W(U) and an upper limit defined by upper value W(L).

In some illustrative examples, lower limit 316 of value range 315, as defined by lower value L of noise floor 313, may be a value larger than 20 dB and/or smaller than 45 dB. Upper limit 317 of value range 315, as defined by upper value U of noise floor 313, may be a value larger than 45 dB and/or smaller than 80 dB. A size of value range 315 of noise floor 313 may range between 20 dB and 40 dB.

Within value range 315 and with increasing values of noise floor 313, a proportion of audio signal SI processed in first path P1 decreases in mixed signal SM relative to a proportion of audio signal SI processed in second path P2. In some examples, as illustrated, weighting 314 decreases monotonously and/or continuously within value range 315 with increasing noise floor 313. E.g., weighting 314 decreases linearly. In some examples, as illustrated, weighting 314 has a substantially constant value outside of value range 315. In some examples, lower limit 316 and/or upper limit 317 of value range 315 may represent a knee (or knee point) of mixing scheme 310.

In some examples, weighting 314 may assume any values between 0, which may correspond to a proportion of the audio signal processed in first path P1 included in mixed signal SM of 0 %, and 1, which may correspond to a proportion of the audio signal processed in first path P1 included in mixed signal SM of 100 %. E.g., upper limit W(L) of weighting 314 may correspond to a value of 1 or smaller, and lower limit W(L) of weighting 314 may correspond to a value of 0 or larger.

In some examples, e.g., to ensure a desirable and/or minimum proportion of the audio signal processed in first path P1 included in the mixed signal, lower limit W(L) of weighting 314 may be provided larger than 0. In some examples, lower limit W(L) of weighting 314 may be 0.3, corresponding to a proportion of the audio signal processed in first path P1 included in mixed signal SM of at least 30 %. In some examples, lower limit W(L) of weighting 314 may be 0.4, corresponding to a proportion of the audio signal processed in first path P1 included in mixed signal SM of at least 40 %. E.g., weighting 314 may assume any values between 0.3 and 1, or any values between 0.4 and 1.

In some examples, mixing ratio may further depend on the SNR of audio signal SI. Mixing scheme 310 may then define a mapping of different values of the noise floor and different values of the SNR to corresponding values of mixing ratio 312. In some examples, value range 315 of noise floor 313 may beshifted to larger values of noise floor 313 with increasing values of the SNR. Some examples of such a mapping are illustrated below in conjunction with FIGS. 7 and 8.

Determining the mixing ratio further depending on the SNR may allow to account for a distortion of the noise floor estimate in a quiet environment, e.g., a loud speech in quiet, for instance to avoid an excessive gain reduction in quiet environments and/or during good speech intelligibility so as to preserve the natural sound quality.

FIG. 7 illustrates a functional plot 332 of a location shift function 330 which may be applied on mixing scheme 310 to provide, in addition to the dependency on noise floor 313, for a dependency of mixing ratio 314 on an SNR of audio signal SI. Location shift function 330 defines a mapping of different values of the SNR to corresponding values of a location shift. The location shift may be applied on mixing scheme 310 relative to axis of abscissas 313 representative of the noise floor. In functional plot 332, the SNR is indicated on an axis of abscissas 333. The location shift is indicated on an axis of ordinates 334. Further illustrated in FIG. 7 are discrete points 341, 342, 343, 344 of location shift function 330 for different values of SNR 333.

Location shift function 330 comprises a value range 335 of SNR 333 in which value range 315 of noise floor 313 (as illustrated in FIG. 6) is shifted to larger values of noise floor 313. Location shift function 330 increases within value range 335 of SNR 333. As a result, when the SNR increases within value range 335, location shift function 330 defines an increase of the values in noise floor range 315 for which the mixing ratio (in particular weighting 314, e.g., the FGW) decreases. Value range 335 has a lower limit 336 defined by a lower value L of SNR 333 and an upper limit 337 defined by an upper value U of SNR 333. Correspondingly, location shift 334 assumes a lower value LS(L) for the lower value L of SNR 333, and an upper value LS(U) for the upper value U of SNR 333. A corresponding value range of location shift 334 may have a lower limit defined by lower value LS(L) and an upper limit defined by upper value LS(U). In some examples, location shift function 330 increases continuously, e.g., linearly, in value range 335. In some examples, as illustrated, location shift function 330 has a substantially constant value outside of value range 335. In some examples, lower limit 336 and/or upper limit 337 of value range 335 may represent a knee (or knee point) of location shift function 330.

In some illustrative examples, lower limit 336 of value range 335, as defined by lower value L of SNR 333, may be a value larger than 10 dB and/or smaller than 20 dB. Upper limit 337 of value range 315, as defined by upper value U of SNR 333, may be a value larger than 20 dB and/or smaller than 30 dB. A size of value range 335 of SNR 333 may range between 5 dB and 20 dB.

In some examples, location shift 334 may be defined in units of decibels (dB). In some examples, location shift 334 may be defined in units of a percentage relative to value range 315, e.g., lower limit 316 or upper limit 317 of value range 315 or a size of value range 315. In some illustrative examples, upper limit LS(U) of location shift 334 may be a value larger than 5 dB and/or smaller than 20 dB. Lower limit LS(L) of location shift 334 may be zero.

FIG. 8 illustrates a functional plot 362 of mixing schemes 371, 372, 373, 374. Mixing scheme 371 corresponds to mixing scheme 310 illustrated in FIG. 6. Mixing schemes 371, 372, 373, 374 illustrate the effect of location shift function 330. In particular, point 341 on location shift function 330 is attributed to mixing scheme 371, point 342 to mixing scheme 372, point 343 to mixing scheme 373, and point 344 to mixing scheme 374.

Points 342, 343 are, as illustrated in FIG. 7, inside value range 335 of SNR 333. FIG. 8 illustrates the corresponding shift of mixing schemes 372, 373 relative to mixing scheme 371 to the larger noise floor values. In particular, lower limits 316 of value range 315 of noise floor 313 in mixing schemes 372, 373 are shifted to larger noise floor values as compared to lower limit 316 in mixing scheme 371. Correspondingly, upper limits 317 of value range 315 in mixing schemes 372, 373 are shifted to larger values of noise floor 313. As a result, value range 315 of noise floor 313 in mixing schemes 372, 373 is shifted the larger noise floor values relative to mixing scheme 371. In some examples, lower limits 316 and upper limits 317 may be shifted by an equal amount, e.g., such that a size of value range 315 of noise floor 313 may be preserved in mixing schemes 371 – 374. In some examples, lower limits 316 and upper limits 317 may be shifted by a different amount, e.g., such that a size of value range 315 of noise floor 313 may differ in mixing schemes 371 – 374.

Mixing scheme 371 is attributed to point 341 of location shift function 330 which is associated with an SNR value smaller than value range 335. For SNR values smaller than value range 335, location shift function 330 may have a minimum value, which may be constant, e.g., zero. As a result, value range 315 in mixing scheme 371, in particular lower and upper limit 316, 317 of value range 315, is not shifted when the SNR is smaller than value range 335. Mixing scheme 374 is attributed to point 344 of location shift function 330 which is associated with an SNR value larger than value range 335. For SNR values larger than value range 335, location shift function 330 may have a maximum value, which may be constant. As a result, value range 315 in mixing scheme 374, in particular lower and upper limit 316, 317, is maximally shifted, i.e., remains shifted to the maximum value, when the SNR is larger than value range 335.

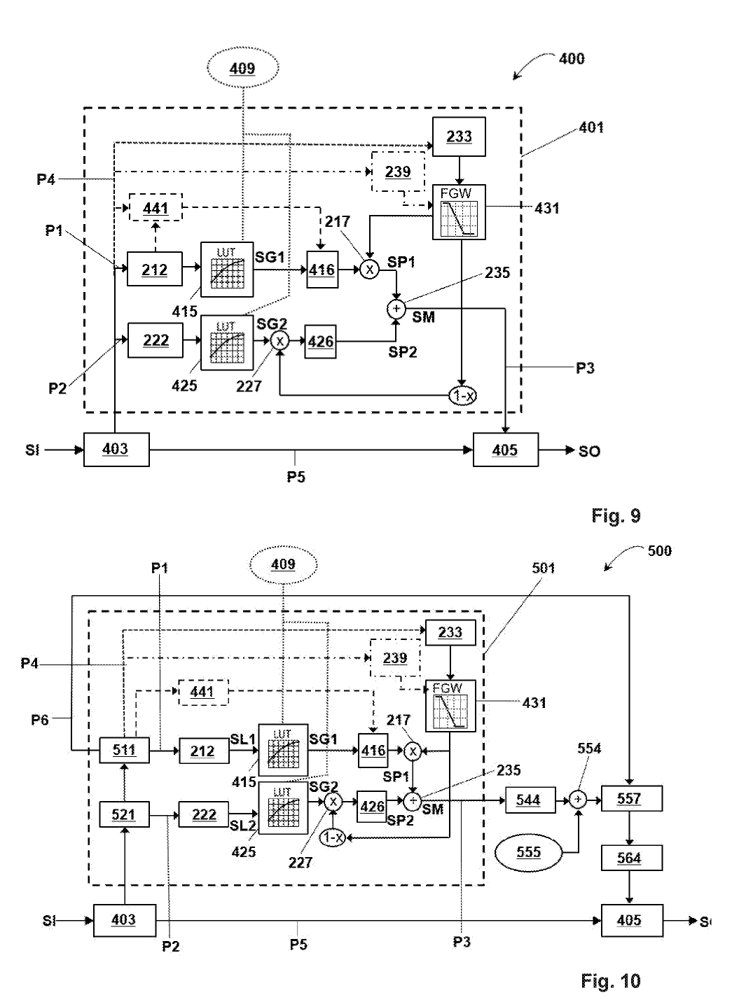

FIG. 9 is a schematic block diagram of a signal processing algorithm 400 for processing an input audio signal SI, which may be received from audio input unit 113, to obtain an output audio signal SO, which may be output by audio output unit 117. E.g., algorithm 400 may be executed by processor 104 of hearing device 101. Algorithm 400 comprises an algorithm 401 for signal level detection of an audio signal SI on separate signal paths P1, P2 to provide for a gain adjustment depending thereon.

Algorithm 400 further comprises a forward signal path P5 bypassing algorithm 401. Forward path P5 comprises an analysis unit 403 followed by a synthesis unit 405. Analysis unit 403 can receive audio signal SI. Analysis unit 403 comprises a time-to-frequency converter to distribute audio signal SI in a number of channels of different frequency bands. The band-distributed audio signal SI is input into algorithm 401 connected in parallel to forward path P5 to provide for the separate processing in first path P1 and second path P2 for the level detection. The frequency bands of audio signal SI are further passed on path P5 to synthesis unit 405. Synthesis unit 405 further receives mixed signal SM output by algorithm 401 via path P3. Synthesis unit 405 can be configured to apply the gain adjustment to audio signal SI as indicated by mixed signal SM. To this end, synthesis unit 405 may be configured to run algorithms for processing input signal SI and/or mixed signal SM in the different frequency bands and/or to provide for signal conversion back from the frequency domain into a time domain and/or any other operation, so as to obtain output signal SO. Synthesis unit 405 may thus more generally be referred to as a signal processing unit (SPU).

Algorithm 401 represents some implementations of algorithm 201 for the level dependent gain adjustment, as illustrated in FIG. 3. First gain determining module 215 of algorithm 201 on first path P1 is implemented in algorithm 401 as a first gain table module 415 followed by a first signal smoothing module 416. Second gain determining module 225 of algorithm 201 on second path P2 is implemented in algorithm 401 as a second gain table module 425 followed by a second signal smoothing module 426. First gain table module 415 is configured to determine, in a first gain value determining operation, a gain value to be applied on audio signal SI so as to provide for a first gain value signal SG1 indicative of the determined gain value. Second gain table module 425 is configured to determine, in a second gain value determining operation, a gain value to be applied on audio signal SI so as to provide for a second gain value signal SG2 indicative of the determined gain value. Mixing ratio determination module 231 of algorithm 201 is implemented in algorithm 401 as a FGW determination module 431. FGW determination module 431 is configured to determine the mixing ratio as the fast gain weight, as described above.

Gain table module 415, 425 is configured to determine the gain value in accordance with a gain table defining a mapping between different values of the signal level, as detected by level detector 212, 212, to corresponding values of the gain. The gain value may be determined depending on the frequency of audio signal SI, e.g., for a plurality of frequency bands input into algorithm 401 by analysis unit 403. As illustrated, the gain table applied by module 415, 425 may be implemented as a look up table (LUT). First gain determining operation 215 then comprises a gain value determination performed by first gain table module 415 in which the gain value is determined from the gain table depending on the level of audio signal SI in first path P1. Audio signal SI processed in first path P1 may then be indicative of the determined gain value. Correspondingly, second gain determining operation 225 comprises a gain value determination performed by second gain table module 425 in which the gain value is determined from the gain table depending on the signal level of audio signal SI in second path P2. Audio signal SI processed in second path P2 may then be indicative of the determined gain value. In same examples, gain table modules 415, 425 are configured to apply an equal gain table on first and second path P1, P2. In some examples, a different gain table may be applied on first and second path P1, P2. E.g., the different gain tables may be adapted, or optimized, for the faster processing in path P1, and the slower processing in path P2. E.g., the gain tables may differ by an offset to compensate a loudness difference of audio signal SI processed in the different paths P1, P2.

In some examples, the gain table applied by module 415, 425 is configured to compensate for an individual hearing loss of the user. Compensating for hearing loss may require a precise gain adjustment to amplify sounds in a way that restores audibility while maintaining a natural listening experience. This may be achieved by a dynamic range compression (DRC), which applies a nonlinear gain function to audio signal SI to accommodate the reduced dynamic range of individuals with hearing impairments. The DRC can be implemented using gain table 415, 425 mapping input sound levels to appropriate gain values based on the user’s specific hearing loss profile.

Gain table 415, 425 may be derived through a fitting process, where the user's audiometric thresholds are analyzed to determine the necessary amplification across different frequencies and input levels. To this end, a fitting software 409 may be employed allowing an adjustment of the gain table, e.g., in a clinical fitting procedure performed by a health care professional (HCP), or in a self-fitting procedure performed by the user himself. Fitting software 409 may derive appropriate sound levels and frequency dependent gain values of gain table 415, 425 based on the user’s specific hearing loss profile, e.g., to provide for DRC. Further, fitting software 409 may automatically account for differences of gain tables 415, 425 for the processing in different paths P1, P2, e.g., a different offset.

First signal smoothing module 416 is configured, in a first smoothing operation, to smooth first gain value signal SG1during the processing in first path P1. Second signal smoothing module 426 is configured, in a second smoothing operation, to smooth second gain value signal (SG2) during the processing in second path P2. In some examples, a delay caused by first smoothing operation 416 is smaller as compared to second smoothing operation 426. In particular, first signal smoothing module 416 may be configured to provide for a faster smoothing of audio signal SI than second signal smoothing module 426.

Providing for a smoothing of first and second gain value signal SG1, SG2 in gain adjustment operations 215, 225 can provide for a reducing of signal fluctuations and/or a mitigation of abrupt changes of the gain application to ensure a natural and comfortable listening experience for the user. The smoothing may particularly relevant for DRC, where rapid fluctuations in input sound levels could otherwise lead to perceptible distortions or unnatural artifacts.

In some examples, the smoothing may include a low pass filtering. Applying a low pass filter (LPF) on audio signal SI can allow low-frequency components to pass while attenuating high-frequency noise. Other implementations of the smoothing of audio signal SI may include, for example, a moving average filter, which may calculate an average of past samples for smoothing out rapid changes, an exponential smoothing, which may apply a weighted average in which recent samples have more influence, a Gaussian smoothing, where a Gaussian kernel can be applied for a weighted averaging, a wavelet denoising, where high frequency noise is removed, a Savitzky-Golay Filter, which may fit a polynomial to a moving window of data, a median filtering, which may replace each sample with a median of neighboring samples, an envelope smoothing, where the signals’ envelope is extracted, and/or the like.

Since the smoothing process operates within two distinct signal paths P1, P2, characterized by a faster and a slower processing, each path P1, P2 can employ a separate smoothing mechanism 416, 426 which may be tailored to its respective role in gain adaptation. In particular, first path P1 may prioritize a responsiveness to rapid level variations, while second path P2 may ensure more gradual adjustments that preserve the overall signal integrity.

In some examples, first smoothing operation 416 is adjustable depending on a characteristic of audio signal SI, e.g., a characteristic of the signal level. In some examples, the characteristic comprises a presence of an onset in audio signal SI, e.g., the onset of a speech. To this end, a detector 441 of the characteristic of audio signal SI, e.g., an onset detector, may be employed. In some examples, as illustrated, detector 441 may determine the characteristic of audio signal SI, e.g., the onset detection, based on the signal level determined by first level detector 212. In some examples, as also illustrated, detector 441 may determine the characteristic of audio signal SI based on receiving audio signal SI via a separate path, i.e., independently form first and second path P1, P2. Based on the detected characteristic of audio signal SI, characteristic detector 441 may adjust, e.g., steer, first smoothing operation 416 in a dynamic way.

First path P1 may thus incorporate a fast smoothing mechanism 416 which may dynamically adjust its response to sudden changes in signal level of audio signal SI. In some examples, mechanism 416 may be adaptive in its release time, which may allow it to react appropriately to different acoustic scenarios. To illustrate, when the system detects a loud sound followed by a sudden level decrease, the smoothing function may assess whether an onset is present—such as speech or any other modulated, informative signal. If an onset is identified, the gain may be rapidly increased to restore audibility, ensuring that critical elements of the signal, such as consonants in speech, remain perceptible to the listener. This adaptive approach may prevent an excessive reduction in gain after loud transient sounds, thereby improving speech intelligibility and overall listening comfort.

Conversely, second smoothing operation 416 may employ a slow smoothing mechanism governing the long-term adaptation of gain values. The slower response may ensure that the system does not overreact to transient fluctuations, thereby maintaining a stable and consistent perception of loudness.

Overall, first gain adjustment operation 215, which is performed by gain table module 415 and first signal smoothing module 416 at first path P1, may provide for a high temporal resolution of the audio signal SI processing. This may account for an improved audibility of softer signal portions in audio signal SI, e.g., consonants in a clean speech. In the context of DRC, first gain adjustment operation 215 may also be referred to as a fast acting DRC. Second gain adjustment operation 225, which is performed by gain table module 425 and second signal smoothing module 426 at second path P2, may provide for a low temporal resolution of the audio signal SI processing. This may account for a reduction or avoidance of an overamplification of noise, e.g., during speech pauses. In the context of DRC, second gain adjustment operation 225 may also be referred to as a slow acting DRC.

In the illustrated example, the first weighting 217 is applied to audio signal SI after first smoothing operation 416, and second weighting 227 is applied to audio signal SI between second gain value adjustment operation 425 and second smoothing operation 426. In this way, by postponing the application of first weighting 217 after first smoothing operation 416, the dynamic adjustability of first smoothing operation 416 may be accounted for so that first weighting 217 is accurately applied on the current adjustment. Further, by applying second weighting 227 at an earlier stage of second path P2 as compared to first weighting 217 of first path P1, the slower processing at the second path P2 may be accounted for.

FIG. 10 is a schematic block diagram of another signal processing algorithm 500 for processing an input audio signal SI to obtain output signal SO, which may be performed by processor 104. Algorithm 500 comprises an algorithm 501 for signal level detection of an audio signal SI on separate signal paths P1, P2 to provide for a gain adjustment.

Gain adjustment algorithm 501 further comprises a band specification module 521. Band specification module 521 can be configured to provide, based on the band-distributed audio signal SI received from analysis unit 403, for a specified number N2 of frequency bands of audio signal SI which are required by second level detector 212. In some examples, N2 may correspond to a number between 10 and 50 frequency bands of audio signal SI. E.g., audio signal SI may be split in Bark bands, e.g., 24 critical bands according to the Bark scale. In some examples, band specification unit 521 may be implemented as a band-sum unit which may sum up the predetermined number N2 of bands (or sub-bands) from the band-distributed audio signal SI received from analysis module 403. The N2 frequency bands of audio signal SI provided by band specification module 521 are then fed into second level detector 222 at second path P2 to detect the signal level of each band.

Further, the N2 frequency bands of audio signal SI are fed into a band coupling module 511. Band coupling module 511 can be configured to provide, based on the N2 frequency bands of audio signal SI, for a specified number N1 of frequency bands of audio signal SI which are required by first level detector 212. N1 may be smaller than N2, which may improve the detection efficiency and/or detection speed of first level detector 212 relative to second level detector 212. In some examples, band coupling module 511 may also be implemented as a band-sum unit which may sum up the predetermined number N1 of bands (or sub-bands) from the N2 bands received from band specification module 521. The N1 frequency bands of audio signal SI are then fed into first level detector 212 at first path P1 to detect the signal level of each band. Further, the N1 frequency bands of audio signal SI may be fed into NFE 233 and/or SNRE 239 and/or audio signal characteristic detector 441.

Algorithm 500 further comprises a gain limiter 544. Gain limiter 544 is configured to limit the gain of mixed signal SM to a maximum value, e.g., to avoid overamplification that could lead to distortion or feedback. The gain limited audio signal can then be combined, at processing step 554, e.g., mixed, with audio signal SI split in N1 frequency bands provided by band coupling module 511. Further, at processing step 554, the combined audio signal may be modified, or the mixing ratio may be controlled, by a volume controller 555. E.g., volume controller 555 may be adjustable via a user interface, which may be provided at hearing device 101 or a remote device, so as to allow the user to control the volume of output signal SO when outputted by audio output unit 117. A maximum power output (MPO) limiter 557 is further provided to limit the maximum output power of the combined and/or volume controlled audio signal, e.g., by ensuring that the output power does not exceed a predefined threshold so as to avoid damage of components and/or distortion of the signal. The signal then passes through a gain cleaning module 564, before the signal is fed into synthesis unit 405. Gain cleaning module 564 can be configured to ensure consistent and controlled gain values, e.g., to prevent gain build-up, maintain headroom, correct gain variations, etc.

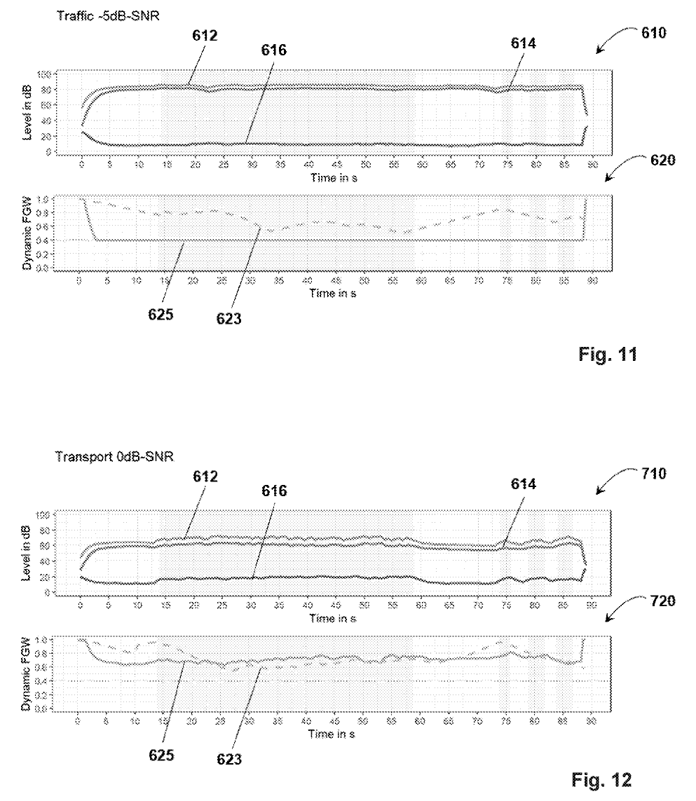

FIG. 11 illustrates a graph 610 of measured characteristics 612, 613, 614 of an acoustic environment in a timeframe of ca. 100 seconds. The acoustic environment exhibits a traffic like noise with an averaged SNR of ca. – 5dB. Time is indicated on an axis of abscissas. A signal level in dB is indicated on an axis of ordinates. The measured (or filtered) characteristics include a sound pressure level 612 which may be represented by the signal level of input audio signal SI. The characteristics further include an estimate of the noise floor 614, which may be obtained by NFE 233. The characteristics further include an estimate of the SNR 616, which may be obtained by SNRE 239.

FIG. 11 further illustrates a graph 620 of plots 623, 635 of first weighting 217, in particular the FGW, over time which may be obtained in this acoustic environment. Time is indicated on an axis of abscissas. The corresponding FGW value is indicated on an axis of ordinates. The plots include a classifier based FGW 623 in which the FGW value has been obtained based on an input of a sound scene classifier of hearing device 101. The plots further include a noise floor based FGW 625 in which the FGW value has been obtained based on an input of NFE 233, corresponding to noise floor estimate 614, according to the principles described above.

FIG. 12 illustrates a graph 710 sound level 612, noise floor 614, and SNR 616 corresponding to graph 610 but measured in a different acoustic environment characteristic for a transport situation with an averaged SNR of ca. 0 dB. FIG. 12 further illustrates a graph 720 of classifier based FGW 623 and noise floor based FGW 625 in this environment.

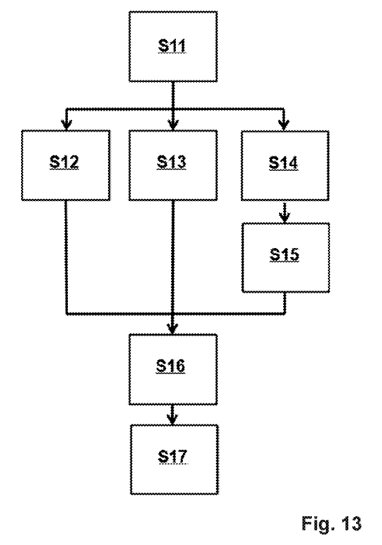

The empirical measurements shown in FIGS. 12 and 13 demonstrate that noise floor based FGW 625 exhibits a more stable behavior than classifier based FGW 623. The observed FGW range, plotted for classifier-driven 623 and NFE-driven 625 methods, highlights the reduced variability in the proposed solution based on the noise floor estimate. The reduction in fluctuations contributes to a more stable and predictable listening experience.

In some examples, an optimization of the NFE-driven FGW calculation may be achieved by adhering to strict performance criteria. E.g., for speech in noise or loud noise, the FGW should converge rapidly to lower values, e.g., values around 0.4 as indicated in FIG. 11 and 12 by a diagonal reference line, while maintaining a monotonous relationship, even in difficult situations (e.g., a low SNR and/or large noise floor) and while also exhibiting less variations especially during speech pauses. The measurements shown in FIGS. 11 and 12 confirm that this requirement is met, as the NFE-driven FGW 625 consistently reflects the expected downward trend in the more challenging listening conditions. Additionally, the stability of FGW 625 is particularly evident during speech pauses, where excessive variations in gain could otherwise introduce perceptual artifacts. When comparing classifier-driven FGW 623 and NFE-driven FGW 625 in the traffic-like noise environment with continuous and intermittent speech, the results clearly indicate that the NFE approach ensures a more predictable FGW response, particularly when speech starts or stops.

Furthermore, perceptual evaluations also confirm that changes between FGW values of 0.4 and 1.0 are minimally perceivable so that unnatural shifts in the perceived volume can be prevented.

FIG. 13 illustrates a block flow diagram for an exemplary method of processing an audio signal in a hearing device. The method may be executed, e.g., by processor 104 of hearing device 101. At operation S11, audio signal SI is received. At operation S12, audio signal SI is processed in first path P1, and, at operation S13, audio signal SI is processed in second path P2, wherein each path P1, P2 is associated with detecting a signal level of audio signal SI for applying a gain adjustment to the audio signal depending on the signal level. At operation S14, a noise floor of audio signal SI is estimated. At operation S15, a mixing ratio is determined depending on the noise floor. At operation S16, mixed signal SM is generated by mixing the audio signal processed in first path P1 and the audio signal processed in second path P2 in accordance with the mixing ratio. At operation S17, an output signal is provided based on the mixed signal for an audio output unit configured to output the output signal.

While the principles of the disclosure have been described above in connection with specific devices, systems and methods, it is to be clearly understood that this description is made only by way of example and not as limitation on the scope of the invention. The above described embodiments are intended to illustrate the principles of the invention, but not to limit the scope of the invention. Various other embodiments and modifications to those embodiments may be made by those skilled in the art without departing from the scope of the present invention that is solely defined by the claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A method of audio processing in a hearing device to provide for a gain adjustment, the method comprising:
receiving an audio signal from an audio input unit;
processing the audio signal in a first path and a second path, wherein each path is associated with detecting a signal level of the audio signal for applying a gain adjustment to the audio signal depending on the signal level, and wherein the processing in the first path is adapting faster to changes of the signal level than the processing in the second path;
generating a mixed signal by mixing the audio signal processed in the first path and the audio signal processed in the second path in accordance with a mixing ratio; and
providing an output signal based on the mixed signal for an audio output unit configured to output the output signal;
characterized by
estimating a noise floor of the audio signal; and
determining the mixing ratio depending on the noise floor.

2. The method of claim 1, wherein the mixing ratio is determined such that, within a predetermined value range of the noise floor, the mixed signal comprises a larger proportion of the audio signal processed in the first path when the noise floor is estimated at a smaller value, and a smaller proportion of the audio signal processed in the first path when the noise floor is estimated at a larger value.

3. The method of claim 2, further comprising:
estimating a signal to noise ratio of the audio signal; and
determining the mixing ratio further depending on the signal to noise ratio.

4. The method of claim 3, wherein said predetermined value range of the noise floor is shifted to larger values of the noise floor with increasing values of the signal to noise ratio.

5. The method of claim 1, wherein the determining the mixing ratio depending on the noise floor comprises:
evaluating the noise floor in a mixing scheme defining a mapping between different values of the noise floor and corresponding values of the mixing ratio.

6. The method of claim 5, wherein the mixing scheme comprises:
a value range of the noise floor in which the mixing ratio is determined such that, with increasing values of the noise floor, a proportion of the audio signal processed in the first path decreases in the mixed signal relative to a proportion of the audio signal processed in the second path.

7. The method of claim 5, wherein the mixing scheme includes a first weighting for the audio signal processed in the first path and/or a second weighting for the audio signal processed in the second path, wherein the mixing ratio is defined by the first weighting and/or the second weighting.

8. The method of claim 7, wherein the generating the mixed signal comprises:
applying the first weighting to the audio signal processed in the first path and/or applying the second weighting to the audio signal processed in the second path; and
combining the audio signal processed in the first path and the audio signal processed in the second path.

9. The method of claim 1, further comprising:
determining, in a first gain value determining operation, a gain value for the gain adjustment in the first path depending on the signal level so as to provide for a first gain value signal indicative of the determined gain value; and
determining, in a second gain value determining operation, a gain value for the gain adjustment in the second path depending on the signal level so as to provide for a second gain value signal indicative of the determined gain value.

10. The method of claim 9, wherein, in the first and/or second gain value determining operation, the gain value is determined in accordance with a gain table defining a mapping between different values of the signal level to corresponding values of the gain value.

11. The method of claim 9, further comprising
smoothing the first gain value signal in a first smoothing operation performed during the processing in the first path, and
smoothing the second gain value signal in a second smoothing operation performed during the processing in the second path.

12. The method of claim 11, wherein the first smoothing operation is adjustable depending on a characteristic of the audio signal, wherein the adjustment impacts a delay caused by the first smoothing operation.

13. The method of claim 12, further comprising
detecting a presence of an onset in the audio signal,
wherein the characteristic of the audio signal comprises the onset.

14. The method of claim 1, wherein the mixing ratio is determined such that the mixed signal comprises a proportion of the audio signal processed in the first path of at least 30%.

15. A hearing device configured to be worn at an ear of a user, the hearing device comprising
an audio input unit for obtaining an audio signal;
a processor for audio signal processing of the audio signal to obtain an output signal; and
an audio output unit for outputting the output signal so as to stimulate the user’s hearing,
characterized in that the processor is configured to perform the method of claim 1.
